(19) United States
(12) Patent Application Publication
(10) Pub. No.: US 2007/0084481 A1
(43) Pub. Date: Apr. 19, 2007

(54) System and method of cleaning substrates using a subambient process solution

(76) Inventor: Cole S. Franklin, San Clemente, CA (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/544,802

(22) Filed: Oct. 6, 2006

Related U.S. Application Data
(60) Provisional application No. 60/724,495, filed on Oct. 7, 2005.

(51) Int. Cl. B08B 3/12; B08B 6/00; B08B 3/00; C23G 1/00; B08B 7/00

(52) U.S. Cl. 134/1.3; 134/1; 134/33; 134/34; 134/2; 134/103.2; 134/149; 134/184

(57) ABSTRACT

A system and method of cleaning a substrate utilizing sonic energy and a film of subambient gasified process solution that assists in reducing damage to the substrate. In one aspect, the invention is a method comprising: a) supporting a substrate in a substantially horizontal orientation; b) applying a solution comprising a liquid and a dissolved gas to a surface of the substrate so as to form a film of the solution on the surface of the substrate, the solution being at a subambient temperature; c) coupling a transmitter to the film of the solution, the transmitter acoustically coupled to a transducer for generating sonic energy; and d) applying sonic energy through the film of the solution and to the surface of the substrate via the transmitter. The method is especially useful in minimizing damage when cleaning substrates with a surface comprising a topography having technology nodes with a width less than 100 nanometers. The solution is most preferred to be at a temperature that results in the solution being at or near the solution's minimum specific volume, which for aqueous solution is at or near 4° C. In another aspect, the invention is system for cleaning a substrates that, through the use of at least two specially located temperature sensors, maintains the cleaning solution near its maximum density temperature when applied to the substrate(s) while ensuring that the solution does not freeze in the supply line.

Cross-Reference to Related Applications

The present application claim the benefit of U.S. Provisional Patent Application Ser. No. 60/724,495, filed Oct. 7, 2005, the entirety of which is hereby incorporated by reference.

### FIELD OF THE INVENTION

The present invention relates generally to systems and methods for cleaning substrates, and specifically to systems and methods of cleaning semiconductor wafers using sonic energy and subambient cleaning solutions to minimize and/or eliminate damage.

### BACKGROUND OF THE INVENTION

In the field of semiconductor manufacturing, it has been recognized since the beginning of the industry that removing particles from semiconductor wafers during the manufacturing process is a critical requirement to producing quality profitable wafers. While many different systems and methods have been developed over the years to remove particles from semiconductor wafers, many of these systems and methods are undesirable because they cause damage to the wafers. Thus, the removal of particles from wafers must be balanced against the amount of damage caused to the wafers by the cleaning method and/or system. It is therefore desirable for a cleaning method or system to be able to break particles free from the delicate semiconductor wafer without resulting in damage to the device structure.

Existing techniques for freeing the particles from the surface of a semiconductor wafer utilize a combination of chemical and mechanical processes. One typical cleaning chemistry used in the art is standard clean 1 (“SC1”), which is a mixture of ammonium hydroxide, hydrogen peroxide, and water. SC1 oxidizes and etches the surface of the wafer. This etching process, known as undercutting, reduces the physical contact area to which the particle binds to the surface, thus facilitating removal. However, a mechanical process is still required to actually remove the particle from the wafer surface.

For larger particles and for larger devices, scrubbers have been used to physically brush the particle off the surface of the wafer. However, as device sizes shrank in size, scrubbers and other forms of physical cleaners became inadequate because their physical contact with the wafers was causing catastrophic damage to smaller devices.

Recently, the application of acoustical/sonic energy to the wafers during chemical processing has replaced physical scrubbing to effectuate particle removal. The sonic energy used in substrate processing is generated via a source of sonic energy. Typically, this source of sonic energy comprises a transducer which is made of piezoelectric crystal. In operation, the transducer is coupled to a power source (i.e. a source of electrical energy). An electrical energy signal (i.e. electricity) is supplied to the transducer. The transducer converts this electrical energy signal into vibrational mechanical energy (i.e. sonic energy) which is then transmitted to the substrate(s) being processed via a transmitter made of quartz or other suitable material.

The application of sonic energy to substrates has proven to be a effective way to remove particles, but as with any mechanical process, manufacturers still experience damage to the devices. Thus, sonic cleaning of substrates is faced with the same damage issues as traditional physical cleaning. While it is unclear why the sonic energy damages the devices on wafers, it is has been hypothesized that damage is caused by cavitation within the cleaning solution. A large number of variables have been reported to affect cavitation damage.

For example, U.S. Pat. No. 6,039,814 to Ohmia describes how degassing the cleaning solution for frequencies above 500 kHz reduces the cavitation damage. However, degassing the cleaning solution also reduces the cleaning efficiency and requires control over gas levels, which can be difficult.

In the Journal of Applied Physics Vol 37 (1998), a paper entitled Relationship Between Cavitation Threshold and Dissolved Air in Ultrasound in the MHz Range describes vapor cavitation as creating a very large force. The article notes that this force was seen when gas concentrations were low. This, however, does not necessarily mean that when gas concentrations are high there is no vapor cavitation.

In Cavitation 2001, session A2.003, a paper entitled Acoustic Emissions from Micro Bubbles in Ultrasound Field shows how bubble size and frequency can impact shock waves. Although this data is very helpful, it does not explain how to control the size of the bubbles and does not present a suitable solution to the problem.

In a journal paper from Wear 254 (2003) 1-9, entitled Cavitation Eerosion in Waters Having Different Surface Tensions, the abstract states that the reduction of surface tension promotes instabilities in bubble growth causing little or less corrosive power. This paper further notes that there are discrepancies when higher gas concentrations are used due to unknown factors.

In Physics Review Letters, Feb. 16, 1998, an article entitled Water Temperature Dependence of Single Bubble Sonoluminescence, FIG. 4 and corresponding discussion, it is stated that chilled water can increase the stability of the oscillating bubble, increasing the intensity of sonoluminescence from a single bubble sono-luminescence (SBSL) event. The article further notes that at 2.5° C., the bubble can grow larger than at near ambient temperatures when driven at 26.5 kHz. There is no mention of what impact moving to higher frequency would have on bubble growth. Also, the situation is much more complicated in multi-bubble cavitation where larger bubble sizes are not as easily obtained.

In U.S. Pat. No. 5,776,296, Matthews, issued Jul. 7, 1998, a process for removing organic materials from semiconductor wafers is disclosed. The Matthews process involves the use of subambient deionized water with ozone absorbed into the water. The ozonated water flows over the wafers and the ozone oxidizes the organic materials from the wafers to insoluble gases. The ozonated water is prepared in-situ by diffusing ozone into a tank containing wafers and subambient deionized water. Matthews also discloses a tank for the treatment of semiconductor wafers with a fluid and a gas diffuser for diffusion of gases directly into fluids in a wafer treatment tank. While Matthews discloses the combination of sonic energy and a subambient solution to more effectively remove organic materials (i.e. Photoresist stripping) from a wafer, Matthews is not directed to cleaning wafers or controlling damage to the same.

To date, no system or technique exists that controls the erosive power of cavitation events during semiconductor cleaning with sonic energy. As device and node sizes continue to decrease (now reaching the nanometer range) damage problems continue to persist and are becoming more catastrophic to devices on the wafers.

### SUMMARY OF THE INVENTION

It is therefore an object of the present invention to provide a system and method of cleaning substrates using sonic energy.

Another object of the present invention is to provide a system and method of cleaning substrates using sonic energy that reduces damage to devices and or technology nodes on the substrates.

Still another object of the present invention is to provide a system and method of cleaning substrates using sonic energy that reduces damage to devices on the substrates while achieving suitable particle removal efficiency.

Yet another object of the present invention is to provide a system and method of cleaning substrates using sonic energy that controls cavitation within the processing fluid.

A further object of the present invention is to provide a system and method of cleaning substrates using sonic energy that minimizes the size of the gas bubbles in the processing solution and/or reduces the vapor pressure of the various substances in the processing solution.

yet further object of the present invention is to provide a system and method of cleaning semiconductor wafers having a topography having technology nodes with a width of 100 nanometers or less that eliminates and/or reduces damage.

A still further object of the present invention is to provide a system and method of cleaning semiconductor wafers with a solution that is at or near its maximum density.

An even further object of the present invention is to provide a system and method of cleaning semiconductor wafers that maintains the temperature of the cleaning solution at or near its maximum density while eliminating, minimizing the risk of freezing in the supply line.

Applied megasonic energy can enhance particle removal from semiconductor devices during cleaning processes. However, applied megasonic energy can also damage the semiconductor devices being cleaned. In studying the effect on cavitation by changes to chemicals and gases, it has been discovered that the impact of these variables would sometimes change. Increasing the concentration of a substance did not always continue to improve the cavitation erosion problem and many promising chemicals or gas mixtures were not compatible with each other. However, once solutions having subambient temperatures were used, it was discovered that the device damage was significantly reduced and mixing in the other additives became possible. Most surprisingly, it was discovered that sonic energy, in combination with the use of a subambient cleaning solution, could be utilized to clean semiconductor wafers having technology nodes having a width of 100 nanometers or less without substantial damage, something that was previously considered a major hurdle to the industry.

It has been surprisingly discovered that because the solubility of gas in a liquid generally goes up as the temperature of the liquid goes down, the subambient solution performs a greater cushioning effect, thereby protecting the substrate by buffering the cavitation events. It has also been discovered the increased amount of gas in the solution improves cleaning efficiency because the overall gas cavitation activity goes up.

Furthermore, reducing the temperature of the solution to a sub-ambinet condition will also increase the viscosity of the solution. This is also desirable because increased viscosity reduces the turbulence in the delivery of the solution to the process chamber, and eventually to the substrate. This effect is usually characterized in terms of Reynolds Number (Re). Turbulence is undesirable because it generates large and small bubbles in the delivery line, thereby increasing damage to wafer. Therefore, it has been discovered that lowering the turbulence during the delivery of the solution (by increasing the viscosity) reduces the formation of unwanted large bubbles during the delivery technique, and subsequently reduces the damage inflicted on the substrate.

Thus, in one aspect, the invention can be a method of cleaning a substrate comprising: a) supporting a substrate in a substantially horizontal orientation; b) applying a solution comprising a liquid and a dissolved gas to a surface of the substrate so as to form a film of the solution on the surface of the substrate, the solution being at a subambient temperature; c) coupling a transmitter to the film of the solution, the transmitter acoustically coupled to a transducer for generating sonic energy; and d) applying sonic energy through the film of the solution and to the surface of the substrate via the transmitter. Using a solution that has a subambient temperature reduces the size of the gas bubbles in the solution and reduces the vapor pressure of the various substances in solution. As such, the cavitation that occurs as a result of the application of the sonic energy is controlled/buffered, thereby reducing damage to the substrate.

It is preferred, in some embodiments, that the subambient temperature of the solution be at or near a temperature that results in the solution be at or near the solution's maximum density (i.e., minimum specific volume). Using a solution that has a temperature that results in the solution being at or near its minimum specific volume (i.e., maximum density) minimizes the size of the gas bubbles in the solution and reduces the vapor pressure of the various substances in solution.

In some embodiments, it may be preferred that the subambient temperature be a temperature that results in the solution being: (i) within 3 kg/m³ of the solution's maximum density; and/or (ii) within +20° C. of the solution's freezing point. In embodiments where the solution is an aqueous solution, it may be preferred that the subambient temperature be between 2° C. and 10° C., and more preferably about 4° C.

It may be further preferred that the sonic energy be megasonic energy, more preferably having a frequency between 800 and 1100 kHz. A host of gases and liquids can be used to form the solution.

It has been discovered that, in some embodiments, the method may be particularly beneficial and non-damaging when used to clean the surface of a substrate comprising a topography having nodes with a width that is less than 100 nanometers. These nodes can be, for example, oxide trenches, metal lines, gates, etc. and the like. It may be preferred that the surface of the substrate be substantially free of photoresist and other organic residues at the time of cleaning.

In one embodiment, the inventive method may further include chilling the solution from a first temperature to a chilled temperature that is at or below the subambient temperature with a chiller. This is done prior to the solution being applied to the surface of the substrate via a nozzle or other dispensing technique. In such an embodiment, it may be preferred to utilize steps helpful in maintaining the solution at the desired subambient temperature while protecting against freezing in the supply line. In such a case, the method may further comprise measuring the temperature of the solution at an exit of the chiller with a first temperature sensor and measuring the temperature of the solution at the dispenser with a second temperature sensor. Upon the temperature measured by the first temperature sensor being above the subambient temperature, the chilling of the solution within the chiller is increased. Similarly, upon the temperature measured by the second temperature sensor falling below a predetermined value above the freezing point of the solution, the chilling of the solution by the chiller is decreased.

In another aspect, the invention can be a method of cleaning a semiconductor wafer having a device side comprising: a) supporting a substrate in a substantially horizontal orientation within a gaseous atmosphere, the substrate having a device side comprising a topography having nodes with a width that is less than 100 nanometers; b) rotating the substrate; c) applying a solution comprising a liquid and a dissolved gas to the device side of the substrate via a dispenser so as to form a film of the solution on the surface of the substrate, the solution being at a subambient temperature that results in the solution being within 3 kg/m³ of the solution's maximum density; d) coupling a transmitter to the film of the solution, the transmitter acoustically coupled to a transducer for generating sonic energy; and e) applying sonic energy through the film of the solution and to the device side of the substrate via the transmitter.

In yet another aspect, the invention can be a system for cleaning a substrate comprising: a rotatable support for supporting a substrate in a substantially horizontal orientation; a source of a cleaning solution comprising a liquid and a gas; a nozzle for applying a film of the cleaning solution to a surface of a substrate positioned on the support; a transmitter adapted to be positioned in contact with the film of the cleaning solution, the transmitter acoustically coupled to one or more transducers; a supply line fluidly coupling the the source of the cleaning solution to the nozzle; a chiller operably coupled to the fluid line, the chiller having an inlet and an exit, the chiller adapted to chill the cleaning solution passing there through; a first temperature sensor operably coupled to the fluid line at the nozzle; a second temperature sensor operably coupled to the fluid line at the exit of the chiller; and a controller operably coupled to the chiller, the first temperature sensor and the second temperature sensor, the controller programmed to: (1) upon receiving a signal from the first temperature sensor indicative of the cleaning solution being at a temperature above a desired subambient temperature, increasing the chilling of the cleaning solution in the chiller; and (2) upon receiving a signal from the second temperature sensor indicative of the cleaning solution being at a temperature within a predetermined range of the freezing point of the cleaning solution, decreasing the chilling of the solution by the chiller.

In still another aspect, the invention can be a system for cleaning a substrate comprising: a support for supporting at least one substrate in a process chamber; a source of a cleaning solution comprising a liquid and a gas; means for introducing the cleaning solution into the process chamber and in contact with a surface of a substrate positioned in the process chamber; means for supplying sonic energy to a substrate positioned in the process chamber; a supply line fluidly coupling the the source of the cleaning solution to the introduction means; a chiller operably coupled to the fluid line, the chiller having an inlet and an exit, the chiller adapted to chill the cleaning solution passing therethrough; a first temperature sensor operably coupled to the fluid line at the introduction means; a second temperature sensor operably coupled to the fluid line at the exit of the chiller; and a controller operably coupled to the chiller, the first temperature sensor and the second temperature sensor, the controller programmed to: (1) upon receiving a signal from the first temperature sensor indicative of the cleaning solution being at a temperature above a desired subambient temperature, increasing the chilling of the cleaning solution in the chiller; and (2) upon receiving a signal from the second temperature sensor indicative of the cleaning solution being at a temperature within a predetermined range of the freezing point of the cleaning solution, decreasing the chilling of the solution by the chiller.

In another aspect, the invention can be the fluid supply system itself, including the two temperature sensors and control system.

In a further aspect, the invention can be a method of cleaning a substrate comprising: a) supporting a substrate in a process chamber; b) applying a cleaning solution to a first surface of the substrate, the cleaning solution being at a temperature that corresponds to the cleaning solution being at or near a minimum specific volume; and c) applying sonic energy to the substrate during the application of the cleaning solution to loosen particles from the first surface of the substrate to loosen particles from the first surface of the substrate.

In still another aspect, the invention can be a system for cleaning substrates comprising: a process chamber; a support for supporting a substrate in a process chamber; a source of a cleaning solution; means for chilling the cleaning solution; means for applying the chilled cleaning solution to a first surface of the substrate; and means for applying sonic energy to the substrate during the application of the cleaning solution to the first surface of the substrate; and a controller operably coupled to the chiller and programmed to cool the cleaning solution from a first temperature to a temperature that results in the cleaning solution being at or near the cleaning solution's minimum specific volume.

In a still further aspect, the invention is a method of cleaning semiconductor wafers comprising: providing a gaseous cleaning solution having a first temperature; chilling the gaseous cleaning solution to a subambient temperature; applying the gaseous cleaning solution to a wafer supported in a process chamber; and applying megasonic energy to the wafer to clean the wafer.

### BRIEF DESCRIPTION OF THE DRAWINGS

FIG. 1 is a schematic of a megasonic cleaning system according to an embodiment of the present invention.

FIG. 2 is a graph of density v. Temperature for a water-based cleaning solution.

FIG. 3 is a flowchart of a cleaning method according to one embodiment of the present invention utilizing a single-wafer megasonic cleaning system.

### DETAILED DESCRIPTION OF THE DRAWINGS

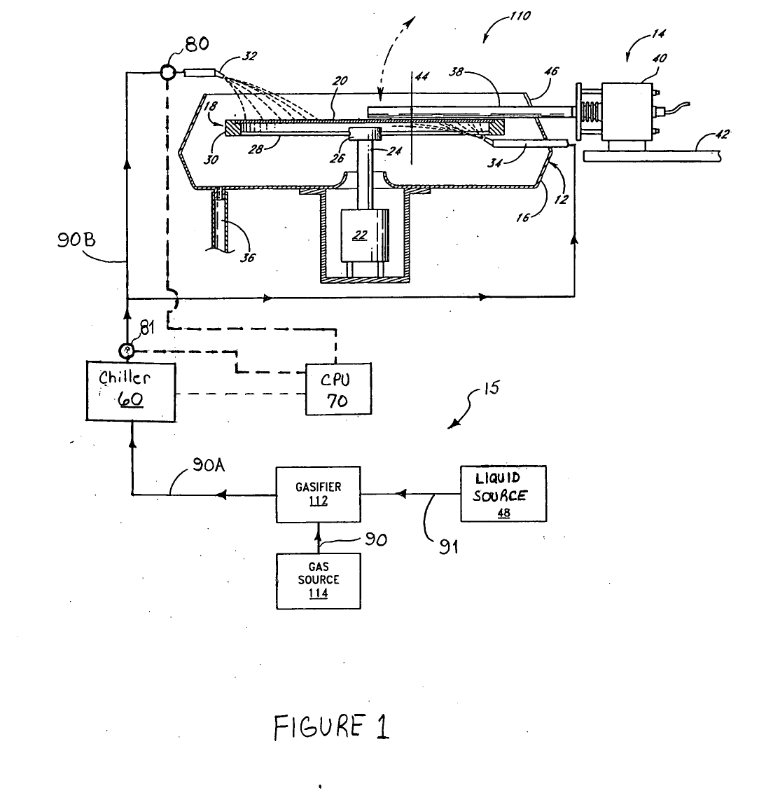

Referring to FIG. 1, a megasonic cleaning system 110 according to one embodiment of the present invention. The megasonic cleaning system 110 generally comprising a process chamber 12, a rod-like probe assembly 14 and a cleaning solution supply and control system 15. While the system of the present invention is exemplified as a single-wafer non-immersion system, the invention is not so limited. Those skilled in the art will appreciate that the concepts and ideas discussed herein can be incorporated into other styles of megasonic cleaning systems, including batch systems, immersionion systems, and the like. Additionally, the concepts and ideas discussed herein can be incorporated into other styles of single-wafer megasonic cleaning systems, including systems that use a plate-like transducer assembly, a lens style transducer assembly, or a pie-shaped transducer assembly. Such transducer assemblies and single-wafer cleaning systems are disclosed, for example in U.S. Pat. No. 6,539,952 to Itkowitz, issued Apr. 1, 2003; U.S. Pat. No. 6,791,242 to Beck et al., issued Sep. 14, 2004; and United States Patent Application Publication 2002/0029788 to Verhaverbeke et al., published Mar. 14, 2002, the entireties of which are hereby incorporated by reference.

The process chamber 12 of the megasonic cleaning system 110 is made up of a tank 16 inside of which is disposed a support 18 adapted to support and/or securely hold a substrate 20, which may be a semiconductor wafer or other similar item that requires a high level of cleanliness. The process chamber 12 comprises a gaseous atmosphere, such as air, nitrogen, or other gases. As used herein, the term process chamber 12 is any volume of space in which a substrate 20 can be processed; it does not require any specific wall arrangement and/or structural arrangement.

The support 18 generally comprises a motor 22, shaft 24, hub 26, spokes 28, and an annular rim 30. The rim 30 supports the substrate 20 in a substantially horizontal orientation as it is rotated about a generally vertical axis by the motor 22, in cooperation with the shaft, hub, spokes, etc. Upper and/or lower dispensers or nozzles 32, 34 dispense a cleaning solution onto the upper and/or lower surfaces of the substrate 20, thereby forming a layer of the cleaning solution on the surfaces of the substrate 20. The dispenser or nozzles 32, 34 can apply the cleaning solution to the substrate 20 via a laminar or turbulent fluid flow or a spraying action. A drain line 36 in the lower end of the tank 16 permits accumulated cleaning solution to exit therefrom.

The probe assembly 14 comprises a rod-like transmitter 38 which is acoustically coupled to a megasonic transducer (not shown) inside of a housing 40. The housing 40 is mounted to a support member 42 so that the shaft of the transmitter 38 extends generally parallel to the surface of the substrate 20 and is separated therefrom by a narrow gap 44. More specifically, the rod-like transmitter 38 comprises an elongate bottom edge that is separated from the substrate by the narrow gap 44. In other embodiments of the transmitter, such as the pie-shaped transducer assembly of U.S. Pat. No. 6,791,242, the elongate edge is the perimeter edge of the pie shaped transmitter plate that extends radially above the wafer surface.

The support member 42, along with the transmitter 14, is retractable or rotatable upward to allow insertion/removal of substrates to the support 18. A slot 46 is provided in the tank 16 to permit rotational movement of the transmitter 38 in and out of the tank. The exemplified transmitter 38 is an elongate probe preferably made of quartz, sapphire, or boron nitride. The invention, however, is not limited to any specific type of transmitter shape or material of construction. As discussed above, the transmitter can take on a wide variety of shapes and configurations, such as, without limitation, a flat plate, a disk, a pie-shaped structure, a curved lens, etc. The transmitter can also be constructed of a wide variety of materials and/or combination of materials.

During general operation of the megasonic cleaning system 100, high-frequency electrical power is supplied to the megasonic transducer, which vibrates at a high, megasonic frequency. If desired, ultrasonic or other frequencies can be used. This vibration is transmitted to the transmitter 38, which also vibrates at a corresponding megasonic frequency. The megasonic vibration of the probe 38 agitates the layer of cleaning solution on the substrate 20 near the probe, creating a cleaning action on the surface of the substrate. Where the lower nozzle 34 is also employed to provide the cleaning solution on the lower surface of the substrate 20, this lower-surface liquid is also agitated in the areas nearest the probe. As the substrate rotates under the probe, substantially the entire surface of the substrate is exposed to the cleaning action generated by the probe and agitated cleaning solution.

Additional details pertaining to the megasonic cleaning system 110 may be found in U.S. Pat. No. 6,140,744, issued Oct. 31, 2000 and entitled WAFER CLEANING SYSTEM, the entirety of which is hereby incorporated by reference.

As discussed above, the application of the megasonic energy can damage the substrate 20, in addition to cleaning it. This damage problem is especially critical when the substrate is a semiconductor wafer having devices thereon. For example, a semiconductor wafer with a topography of technology nodes, such as gate structures, trenches, and metal lines, with a width at or below 100 nm is especially vulnerable to damage during sonic cleaning processes. However, by properly controlling the liquid supply system 15, this damage can be minimized while still achieving the necessary cleaning requirements.

The cleaning solution supply system 15 comprises a gasifier 112, a gas source 114, a liquid source 48, a chiller 60, a supply line 90 (consisting of sections 90A and 90B), a first temperature sensor 80, a second temperature sensor 81 and a controller 70. The gas source 114 and the liquid source 48 are operatively and fluidly coupled to the gasifier 112 via gas line 91 and liquid line 92 respectively. As necessary, the gasifier 112 injects or dissolves the gas into the liquid, thereby forming a cleaning solution. The invention is not limited to any specific gas or liquid. Examples of suitable gases include, without limitation, NH₃, N₂ , O₂, He, Ar, air, CO₂, O₃ and the like. The gas can be any reactive gas, nonreactive gas, or combinations thereof. However, air and N₂ may be preferred. Examples of suitable liquids include, without limitation, deionized water, SC1, SC2, TMAH, oxalic acid, acetic acid, organic solvents, and combinations and diluted versions thereof. The exact gas and liquid used will depend on the cleaning process being performed, the type of substrate being processed, the size of the devices on the substrate, and the susceptibility of the device to damage.

The gasifier 112 may comprise any conventional gas injection or mixing device, such as a membrane contractor. Alternatively, the gasifier 112 may comprise any chamber or reservoir which facilitates exposure of the liquid to the desired gas for a sufficient time to allow the gas to dissolve in the liquid. In one embodiment, the liquid is exposed to the gas until equilibrium is reached for the operating pressure and temperature of the gasifier 112. In another embodiment, the gasifier 112 exposes the liquid to air or other gas(es) at ambient conditions, i.e. room temperature and pressure. It should be noted that the invention is not limited by the presence of the gasifier 112. In some embodiments of the invention, the cleaning solution will not be made at point of use during substrate processing. Instead, the cleaning solution may be pre-made and stored in an auxiliary tank or otherwise provided from a reservoir.

Once the cleaning solution is produced/provided, it is fed to an inlet of the chiller 60 via supply line 90A for cooling to a temperature that is at or below a target subambient temperature that is desired for processing. Chilling the cleaning solution below the target subambient temperature accounts for any heat-up of the cleaning solution that may occur in the supply line 90B.

Preferably, the chiller 60 cools the gasified cleaning solution to a temperature that is well below ambient to minimize the size of the gas bubbles and to reduce the vapor pressure of the various substances in the cleaning solution. Most preferably, the chiller 60 cools the cleaning solution to a temperature that corresponds to the cleaning solution being at or near the cleaning solution's minimum specific volume (which is also the cleaning solution's maximum density) while still remaining in the liquid state.

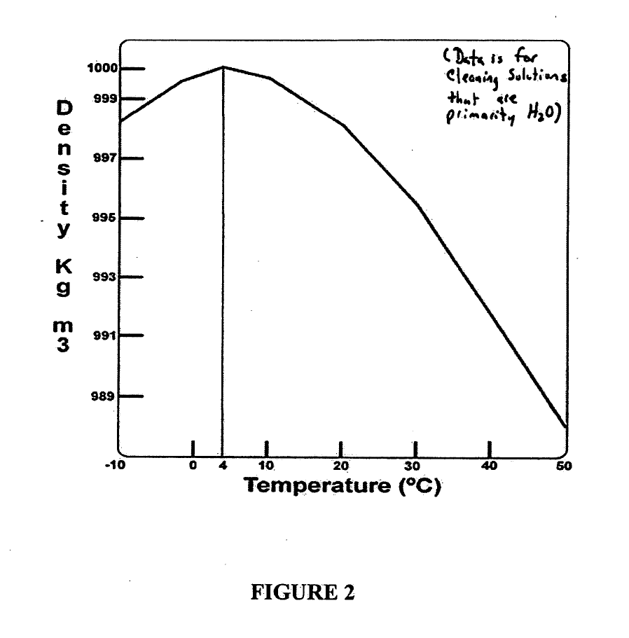

For example, for a cleaning solution that is primarily water (such as is the case with dilute and ultradilute solutions), the temperature at which the cleaning solution will reach its minimum specific volume/maximum density is at about 4° C. This is illustrated in the thermodynamic graph of FIG. 2. Cooling the cleaning solution to a temperature where the specific volume is at or near its minimum, reduces the gas bubbles to their minimum size.

As mentioned above, a process solution's contents can vary widely. Thus, the exact temperature at which any given process solution will be at or near its minimum specific volume can vary greatly. However, for any given process solution, the temperature where the process solution exhibits a minimization in specific volume will be the preferred operating point. In the case where additives to the water change the freezing point, or other liquids are used with lower freezing points, it is possible for the desired temperature to be well below 4° C. The desired processing temperature of any given process solution can be determined by constructing a graph similar to that in FIG. 2 for that specific process solution.

Referring back to FIG. 1, the chiller 60 is operably connected to and controlled by a controller 70. The controller 70 controls all of the fluid flow for the system 110 through operable connection to pumps, valves, etc. A detailed explanation of these functions is not necessary, as this knowledge well within the level of those ordinarily skilled in the art. A first temperature sensor 80 is located downstream of the chiller 60 to monitor the temperature of the chilled cleaning solution at the point of exit from the chiller 60. A second temperature sensor 81 is located further downstream of the chiller 60 to monitor the temperature of the chilled cleaning solution at the nozzle 32. The temperature sensors 80, 81 are fluidly coupled to the supply line 90B in the locations illustrated and operably coupled to the controller 70 for the transmission of signals.

By strategically locating the temperature sensors 80, 81 at the exit of the chiller 60 and at the nozzle 32, the temperature of the cleaning solution can be maintained near the desired subambient temperature for processing (which may be very close to the freezing point) while ensuring that the cleaning solution does not freeze in the supply line 90B. As discussed in greater detail below, the controller 70 will take the appropriate actions in adjusting the sheller 60 as needed upon receiving the measurement signals from the sensors 80, 81.

The properly programmed controller 70 automates the fluid supply system 15 and the temperature control of the cleaning solution being supplied to the process chamber 12. All of the hardware/components of the fluid supply system 15 are electrically and operably coupled to the controller 70, such as the temperature sensors 80, 81, the internal control components of the chiller 60 and, if desired, the hardware required to generate the megasonic energy. Moreover, while not illustrated, the fluid supply system 15 comprises the necessary valves, pumps, mass flow controllers, etc. That may be needed to operate the cleaning system 110 as desired. Of course, the controller 70 will also be operably and electrically coupled to these devices as needed for automation and control.

The controller 70 can be a suitable microprocessor based programmable logic controller, personal computer, or the like for process control. The controller 70 preferably includes various input/output ports used to provide connections to the various components of the cleaning system 110 that need to be controlled and/or communicated with. The electrical connections are indicated in dotted line in FIG. 1. The controller 70 also preferably comprises sufficient memory to store process recipes and other data, such as thresholds inputted by an operator, processing times, processing conditions, processing temperatures, flow rates, desired concentrations, sequence operations, and the like. The controller 70 can communicate with the various components of the the fluid supply system 15 to automatically adjust and maintain process conditions, such as the temperature of the cleaning solutions, flow rates, etc. as necessary. The type of system controller used for any given system will depend on the exact needs of the system in which it is incorporated.

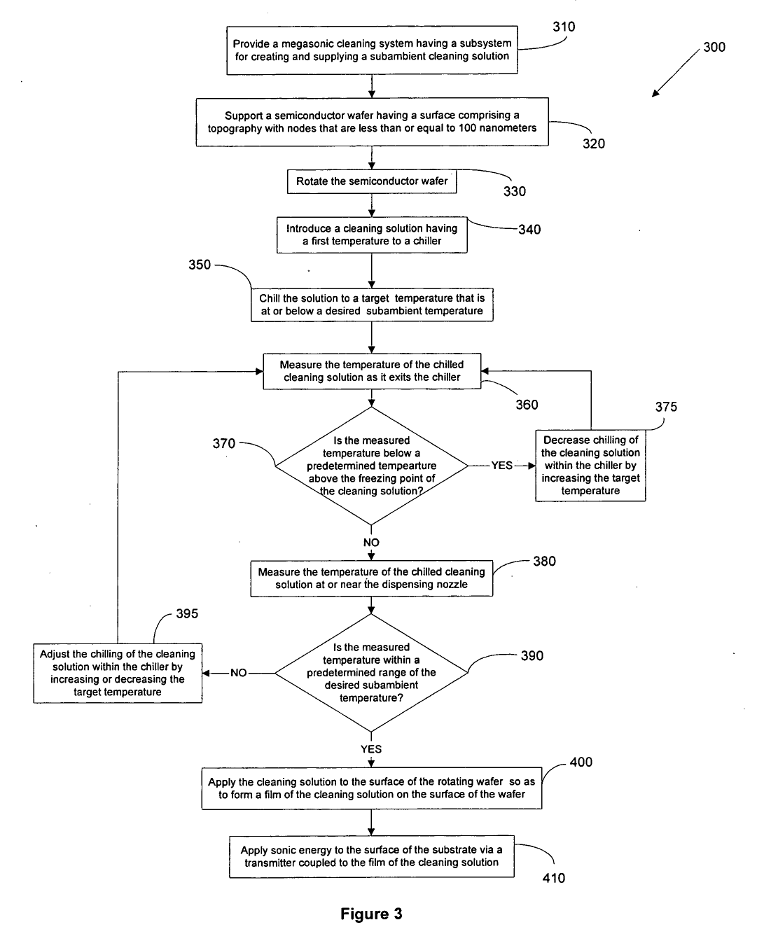

Refereeing now to FIG. 3, a method of cleaning a semiconductor wafer 300 according to an embodiment of the present invention is schematically illustrated. The cleaning method of FIG. 3 will be described in relation to the megasonic cleaning system 110 of FIG. 1 for ease of reference and understanding. However, the inventive method is not so limited and can be carried out on a host of cleaning systems, including both single-wafer and batch immersion tanks.

At step 310, the megasonic cleaning system 110 is provided. A semiconductor wafer 20 is positioned on the support 18 in a horizontal orientation. The semiconductor wafer 20 comprises a surface having topography with technology nodes having a width of 100 nanometers or less and is substantially free of photoresist or other organic residues. The semiconductor wafer 20 is positioned on the support 18 so that the surface having the technology nodes is facing the transmitter (i.e., in this case upward), thereby completing step 320.

The support 18 is then rotated via the motor 22 at a desired rotational speed( i.e., RPM), which in turn rotates the substrate 30 in a substantially horizontal plane. Thus, step 330 is completed.

The appropriate pumps and/or valves are activated so that the desired flow rates of gas and liquid are flowed from the gas and liquid sources 114, 48 respectively and into the gasifier 112. The gasifier 112 creates a cleaning solution by dissolving the gas into the liquid. The fluid flow characteristics of the liquid and gas supplies are controlled by the controller 70 to create the cleaning solution having the desired concentration. Upon being created in the gasifier 112, the cleaning solution is at a first temperature (which is most likely at or above ambine temperature).

The cleaning solution exits the gasifier 112 and flows into the inlet of the chiller 60 via supply line 90A, thus completing step 340. Upon entering the chiller 60, the chiller 60 cools the cleaning solution to a target temperature that results in the cleaning solution being at or below a desired subambient temperature for the cleaning solution during application to the wafer 20. It may be preferred that the target temperature be below the desired subambient temperature to accommodate for heating of the cleaning solution that may occur between the chiller 60 and the nozzle 32.

The desired subambient temperature is most preferably at or near a temperature that results in the cleaning solution being at or near its minimum specific volume. For aqueous solutions, this corresponds to a temperature of about 4° C. In other embodiments of the invention, the desired subambient temperature may be within a predetermined range around the temperature that results in the cleaning solution being at or near its minimum specific volume. For example, the desired subambient temperature may be a temperature that: (1) results in the solution being within 3 kg/mr³ of the solution's maximum density; and/or (2) results in the cleaning solution being within 20° C. of the solution's freezing point. Accordingly, for an aqueous solution, the the desired subambient temperature may be between 2° C. and 10° C.

The controller 70 is programmed to activate and/or control the cooling effect within the chiller 60 to achieve the target temperature. The chiller 60 can be a standard heat exchanger that utilizes a coolant, such as ethylene glycol or the like. The controller 60 can control the level of cooling of the cleaning solution in the chiller 60 by controlling variables such as the temperature, flow rate, etc. of the ethylene glycol coolant. As such, the controller 70 can increase and/or decrease the cooling of the cleaning solution as needed, and thus the resultant temperature of the cleaning solution exiting the chiller 60.

For exemplary purposes, the desired subambient temperature of the cleaning solution is 4° C. and there is an expected heat gain of about 1 ° C. as the cleaning solution travels from the chiller 60 to the nozzle 32. As a result, the target temperature is 3° C. Thus, the chiller 60 (via the controller 70) will chill the cleaning solution to a target temperature of 3° C., completing step 350.

As the cleaning solution exits the chiller 60, temperature sensor 81 repetitively measures the actual temperature of the cleaning solution as it flows into the supply line 90B. The temperature sensor 81 generates signals indicative of the measured temperature and transmits these signals to the controller 70 for analyzing and processing, thus completing step 360.

Upon receiving the signals from the temperature sensor 81, the controller 70 analyses these signals and inquires as to whether the measured temperature is below a predetermined threshold temperature above the freezing point of the cleaning solution. This step is performed to safeguard against freezing in the supply line 90B. For example, assuming that the freezing point of the cleaning solution is 0° C. (and the desired subambient temperature is 4° C.), the predetermined threshold temperature may be approximately 2° C. Thus, the controller inquires as to whether the measured temperature of the cleaning solution by the temperature sensor 81 is below 2° C., completing inquiry 370.

If the answer to inquiry 370 is YES, the controller 70 sends the appropriate control signal to the chiller 60 to decrease the chilling of the cleaning solution within the chiller 60. This can be done by increasing the target temperature of the chiller 60 and making the appropriate adjustments. Thus, step 375 is completed and the method returns to step 360 and will continue in this loop until the answer to inquiry 370 is NO.

When the answer to inquiry 370 is NO, the cleaning solution flows through the supply line 90B without further adjustment to the chiller 60. As the cleaning solution passes by the temperature sensor 80 which is at the nozzle 32, the temperature sensor 80 repetitively measures the actual temperature of the cleaning solution as it flows into the nozzle 32. Similar to above, the temperature sensor 80 generates signals indicative of the measured temperature and transmits these signals to the controller 70 for analyzing and processing, thus completing step 380.

Upon receiving the signals from the temperature sensor 80, the controller 70 analyses these signals and inquires as to whether the measured temperature is within a predetermined range of the desired subambient temperature, which in this case is 4° C. For example, the predetermined range may be +/−0.5° C. This step is performed to keep the cleaning solution as close as possible to the desired subambient temperature when applied to the wafer 20. Thus, the controller inquires as to whether the measured temperature of the cleaning solution by the temperature sensor 80 is within a range of 3.5° C. to 4.5° C., completing inquiry 390.

If the answer to inquiry 390 is NO, the controller 70 sends the appropriate control signal to the chiller 60 to increase or decrease (whichever is needed) the chilling of the cleaning solution within the chiller 60. This can be done by increasing or decreasing the target temperature of the chiller 60 as appropriate. Thus, step 395 is completed and the method returns to step 360 and will continue in this loop until the answer to inquiry 390 is YES. When the answer to inquiry 390 is YES, the cleaning solution flows through the supply line 90B and out of nozzle 32 without further adjustment to the chiller 60.

It should be noted that both temperature sensor 80, 81 are performing their measuring and signal transmission functions concurrently. Similarly, the controller 70 is also concurrently performing inquiries 370 and 390 continuously. As a result, there is the possibility that the controller 70 may come to conflicting directives as to how to appropriately adjust the chiller 60 (i.e., a concurrent directives to increase and decrease the target temperature). This conflicting situation can be dealt with in a variety of ways. For example, the controller 70 can be programmed to recognize one of the temperature sensors 80 or 81 as the dominant signal to obey in such situations. Alternatively, the controller 70 can be programmed to adjust one of the controlling parameters, such as the desired subambient temperature, etc. Properly insulating the supply line 90B will minimize the occurrence of this situation.

At step 400, the cleaning solution is supplied to the process chamber 16. The cleaning solution is applied to the top surface of the wafer 20 via the nozzle 32. As a result, a layer of the cleaning solution is formed on the top surface of the wafer 20, which is the surface having the 100 nanometer or less technology nodes. If desired, a layer of the cleaning solution can also be applied to the bottom surface of the wafer 20 via the nozzle 34.

The film of the cleaning solution on the top surface of the wafer 20 is in contact with and couples the transmitter 38 to the wafer 20. Preferably, conditions are maintained in the process chamber so that the cleaning solution remains at or near the desired subambient temperature during the entire cleaning process described below.

Once the layer of the cleaning solution is formed on the wafer 20, the transducer is activated by the controller 70 (or other sub-system controller). As a result the transducer creates sonic energy which is transmitted to the transmitter 38. The transmitter 38 transmits the sonic energy (which is preferably in the megasonic frequency range) through the layer of chilled cleaning solution and to the wafer 20, thereby facilitating in the removal of particles and other contaminants from the substrate and completing step 410.

Preferably, the sonic energy is transmitted at a frequency between 800 and 1100 kHz, more preferably between 820 and 850 kHz, and most preferably about 841 kHz. The sonic energy is applied to the wafer 20 for a predetermined period of time, preferably less than 1 minute, and most preferably about 30 seconds.

### EXPERIMENT

Identical semiconductor wafers having 80 nm wide and 450 nm tall lines and having silicon nitride particles at 0.1 tm were cleaned using a megasonic transducer using 50 Watts of power for 30 seconds. Experiments were conducted at two different frequencies, 920 kHz and 841 kHz, and at ambient temperature (28° C., representing the prior art) and subambient temperature (15.5°, 10°, and 6° C., representing the invention). The results, reported in Tables 1 and 2 below, demonstrate orders of magnitude decrease in damage using subambient temperatures with small affect on cleaning efficiency.

TABLE 1

| | freq | pre | | post | | | |
|---|---|---|---|---|---|---|---|
| temp ° C. | kHz | cont | cont | cont | PRE | pH | Damage |
| 28 * | 841 | 176 | 8681 | 329 | 98% | 10.64 | 4644 |
| 28 * | 920 | 383 | 9354 | 628 | 97% | 10.64 | 3550 |
| 10 | 841 | 206 | 5499 | 556 | 89% | 10.64 | 0 |
| 6 | 841 | 102 | 16747 | 1056 | 94% | 10.64 | 0 |
| 15.5 | 841 | 265 | 8946 | 1552 | 86% | 10.64 | 1 |
| 15.5 | 920 | 129 | 8606 | 1758 | 81% | 10.64 | 2 |

* = Comparative

TABLE 2

| | | | | | | | | post | | | |
|---|---|---|---|---|---|---|---|---|---|---|---|
| Run # | POWER | PROCESS | Time | temp C. | freq kHz | pre cont | cont | cont | PRE | pH | Damage |
| 1 | 50 | XT1.01000:1 | 30 s | 28 | 841 | 176 | 8681 | 329 | 98% | 10.64 | 4644 |
| 2 | 50 | XT1.01000:1 | 30 s | 28 | 920 | 383 | 9354 | 628 | 97% | 10.64 | 3550 |
| 3 | 50 | XT1.01000:1 | 30 s | 10 | 841 | 206 | 5499 | 556 | 89% | 10.64 | 0 |
| 4 | 50 | XT1.01000:1 | 30 s | 6 | 841 | 102 | 16747 | 1056 | 94% | 10.64 | 0 |
| 5 | 50 | XT1.01000:1 | 30 s | 15.5 | 841 | 265 | 8946 | 1552 | 86% | _10._64 | 1 |
| 6 | 50 | XT1.0 1000:1 | 30 s | 15.5 | 920 | 129 | 8606 | 1758 | 81% | 10.64 | 2 |

In studying the effect on cavitation by changes to chemicals, gases and additives during the experiment, it became clear that no specific gas or chemical could completely control cavitation. However, it was found that CO₂, various alcohols, glycol and other organic chemicals were helpful in reducing damage for some sub 200 nm technology nodes, but some damage still occurred in some substrate types, usually those with feature sizes below 130 nm. Increasing the concentration of any one or combination of the chemicals did not completely solve the cavitation erosion issue until subambient temperatures were used.

The chilled liquid lowered the vapor pressure of its components, reducing the risk of vaporous cavitation events as well as decreasing the size of gas bubbles and gaseous clouds that could form. This was indicated by the increase in density and the minimization of specific volume.

The resulting increase in the viscosity of the cleaning solution at subambient temperatures created higher drag force on the particles, making them easier to remove by physical force rather than chemical undercutting. Moreover, the increased viscosity also reduced the turbulence in the delivery of the process solution to the process chamber. This effect is usually characterized in terms of Reynolds Number (Re). Lowering the turbulence by increasing the viscosity helped to reduce the bubbles formed by delivery technique, thereby reducing damage seen on the wafer.

Because the solubility of gas also increased with the subambient cleaning solution, a cushioning effect was provided, buffering the cavitation events and reducing the damage to the substrate. In this type of environment, the gas cavitation activity increases based on the amount of gas in solution. This added gas content, thus, improved cleaning efficiencies.

The improvement in cleaning without damage reverses its effect near 40° C. for ammonia-water and other chemical-water mixes. This indicates that a reduction of the bubble size by solubility is the most likely controlling factor. The indications that vapor pressure is in control of the damage is less since the vapor pressure continues to go down below 4° C. but damage starts to go back up when the temperature drops below 4° C. The same is true of the delivery technique since the turbulent factors continue to be reduced below 4° C.

The chilled solution alone met the need for damage control while maintaining the high cleaning efficiency seen in normal operations in megasonic cleaning. There is an added benefit in that the chilled solution provides a stable platform for mixing in other additives. The chilled solution allows for cleaning with little or no damage. The subambient effects of the cleaning solution provides a novel process window for applying megasonic energy and eliminating the effects of cavitation erosion for the semiconductor industry.

The foregoing description of the preferred embodiment of the invention has been presented for the purpose of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method of cleaning a substrate comprising:
a) supporting a substrate in a substantially horizontal orientation;
b) applying a solution comprising a liquid and a dissolved gas to a surface of the substrate so as to form a film of the solution on the surface of the substrate, the solution being at a subambient temperature;
c) coupling a transmitter to the film of the solution, the transmitter acoustically coupled to a transducer for generating sonic energy; and
d) applying sonic energy through the film of the solution and to the surface of the substrate via the transmitter.

2. The method of claim 1 wherein step b) further comprises:
dissolving the gas into the liquid to form the solution, the liquid being at a first temperature;
chilling the solution from the first temperature to the subambient temperature; and
applying the chilled solution to the surface of the substrate.

3. The method of claim 1 wherein the subambient temperature is at or near a temperature that results in the solution being within 3 kg/m³ of the solution's maximum density.

4. The method of claim 1 wherein the subambient temperature is at or near a temperature that results in the solution being at or near the solution's minimum specific volume.

5. The method of claim 4 wherein the solution is an aqueous solution and the subambient temperature is between 2° C. and 10° C.

6. The method of claim 5 wherein the subambient temperature is about 4° C.

7. The method of claim 4 wherein the solution is maintained at the subambient temperature during the performance of step d).

8. The method of claim 1 wherein the solution is maintained at the subambient temperature during the performance of step d).

9. The method of claim 1 wherein the sonic energy is megasonic energy having a frequency between 800 and 1100 kHz.

10. The method of claim 1 wherein the subambient temperature is a temperature that corresponds to the solution being within 20° C. of the solution's freezing point.

11. The method of claim 1 wherein the surface of the substrate comprises semiconductor devices having having a width that is less than 100 nanometers.

12. The method of claim 1 wherein the surface of the substrate comprises a topography having nodes with a width that is less than 100 nanometers.

13. The method of claim 12 wherein the nodes are selected from a group consisting of oxide trenches, metal lines and gates.

14. The method of claim 1 wherein the gas is air or nitrogen and the liquid is deionized water.

15. The method of claim 1 wherein the surface of the substrate is substantially free of photoresist and organic residues.

16. The method of claim 1 wherein the surface of the substrate comprises a topography having nodes with a width that is less than 100 nanometers, the surface of the substrate is substantially free of photoresist and organic residues, and the performance of step d) loosens particles from the surface of the substrate without damaging the topography.

17. The method of claim 1 wherein step b) comprises chilling the solution from a first temperature to a chilled temperature at or below the subambient temperature with a chiller prior to the solution being applied to the surface of the substrate via a dispenser, the method further comprising:
measuring the temperature of the solution at an exit of the chiller with a first temperature sensor;
measuring the temperature of the solution at the dispenser with a second temperature sensor;
upon the temperature measured by the first temperature sensor being above the subambient temperature, increasing the chilling of the solution in the chiller; and
upon the temperature measured by the second temperature sensor being within a predetermined range of the freezing point of the solution, decreasing the chilling of the solution by the chiller.

18. A method of cleaning a semiconductor wafer having a device side comprising:
a) supporting a substrate in a substantially horizontal orientation within a gaseous atmosphere, the substrate having a device side comprising a topography having nodes with a width that is less than 100 nanometers;
b) rotating the substrate;
c) applying a solution comprising a liquid and a dissolved gas to the device side of the substrate via a dispenser so as to form a film of the solution on the surface of the substrate, the solution being at a subambient temperature that results in the solution being within 3 kg/m³ of the solution's maximum density;
d) coupling a transmitter to the film of the solution, the transmitter acoustically coupled to a transducer for generating sonic energy; and
e) applying sonic energy through the film of the solution and to the device side of the substrate via the transmitter.

19. The method of claim 18 wherein the nodes are selected from a group consisting of oxide trenches, metal lines and gates; the gas is air or nitrogen and the liquid is deionized water; and the surface of the substrate is substantially free of photoresist and organic residues.

20. The method of claim 18 further comprising:
prior to step c), supplying the solution at a first temperature to a chiller, the first temperature being above the subambient temperature and the chiller being fluidly coupled to the dispenser;
chilling the solution to a chilled temperature at or below the subambient temperature with a chiller;
repetitively measuring the temperature of the chilled solution at an exit of the chiller with a first temperature sensor;
repetitively measuring the temperature of the solution at the dispenser with a second temperature sensor;
upon the temperature measured by the first temperature sensor being above the subambient temperature, increasing the chilling of the solution in the chiller; and
upon the temperature measured by the second temperature sensor being within a predetermined range of the freezing point of the solution, decreasing the chilling of the solution by the chiller.

21. A system for cleaning a substrate comprising:
a rotatable support for supporting a substrate in a substantially horizontal orientation;
a source of a cleaning solution comprising a liquid and a gas;
a nozzle for applying a film of the cleaning solution to a surface of a substrate positioned on the support;
a transmitter adapted to be positioned in contact with the film of the cleaning solution, the transmitter acoustically coupled to one or more transducers;
a supply line fluidly coupling the the source of the cleaning solution to the nozzle;
a chiller operably coupled to the fluid line, the chiller having an inlet and an exit, the chiller adapted to chill the cleaning solution passing therethrough;
a first temperature sensor operably coupled to the fluid line at the nozzle;
a second temperature sensor operably coupled to the fluid line at the exit of the chiller; and
a controller operably coupled to the chiller, the first temperature sensor and the second temperature sensor, the controller programmed to: (1) upon receiving a signal from the first temperature sensor indicative of the cleaning solution being at a temperature above a desired subambient temperature, increasing the chilling of the cleaning solution in the chiller; and (2) upon receiving a signal from the second temperature sensor indicative of the cleaning solution being at a temperature within a predetermined range of the freezing point of the cleaning solution, decreasing the chilling of the solution by the chiller.

22. The system of claim 21 wherein the subambient temperature is a temperature that results in the cleaning solution being within 3 kg/m³ of the cleaning solution's maximum density

23. The system of claim 21 wherein the source of cleaning solution is a gasifier for dissolving the gas into the liquid or a reservoir of the cleaning solution.

24. The system of claim 21 wherein the predetermined range is 1 ° C. to 10 ° C. above the freezing point of the cleaning solution.

25. The system of claim 24 wherein the predetermined range is 3° C. to 5° C. above the freezing point of the cleaning solution.

26. The system of claim 21 wherein the subambient temperature is at or near a temperature that results in the cleaning solution being at or near the cleaning solution's minimum specific volume.

27. The system of claim 1 wherein the cleaning solution is an aqueous solution and the subambient temperature is between 2° C. to 10° C.

28. The system of claim 27 wherein the subambient temperature is at or near 4° C.

29. A system for cleaning a substrate comprising:
a support for supporting at least one substrate in a process chamber;
a source of a cleaning solution comprising a liquid and a gas;
means for introducing the cleaning solution into the process chamber and in contact with a surface of a substrate positioned in the process chamber;
means for supplying sonic energy to a substrate positioned in the process chamber;
a supply line fluidly coupling the the source of the cleaning solution to the introduction means;
a chiller operably coupled to the fluid line, the chiller having an inlet and an exit, the chiller adapted to chill the cleaning solution passing therethrough;
a first temperature sensor operably coupled to the fluid line at the introduction means;
a second temperature sensor operably coupled to the fluid line at the exit of the chiller; and
a controller operably coupled to the chiller, the first temperature sensor and the second temperature sensor, the controller programmed to: (1) upon receiving a signal from the first temperature sensor indicative of the cleaning solution being at a temperature above a desired subambient temperature, increasing the chilling of the cleaning solution in the chiller; and (2) upon receiving a signal from the second temperature sensor indicative of the cleaning solution being at a temperature within a predetermined range of the freezing point of the cleaning solution, decreasing the chilling of the solution by the chiller.
